(19) United States
(12) Patent Application Publication
(10) Pub. No.: US 2026/0259154 A1
(43) Pub. Date: Sep. 3, 2026

(54) TOMOGRAPHY ERROR CORRECTION SYSTEM AND METHOD

(71) Applicant: Psylotech, Inc., Evanston, IL (US)

(72) Inventors: G. Alexis Arzoumanidis, Glenview, IL (US); Brian Bay, Corvallis, OR (US)

(21) Appl. No.: 19/371,514

(22) Filed: Oct. 28, 2025

Related U.S. Application Data
(60) Provisional application No. 63/713,011, filed on Oct. 28, 2024.

(51) Int. Cl. G01N 23/046

(52) U.S. Cl. CPC G01N 23/046; G01N 2223/309; G01N 2223/3306; G01N 2223/401; G01N 2223/611

(57) ABSTRACT

A system including a load frame assembly, an x-ray tomography system, a test specimen and at least one tracking feature. The load frame assembly includes a load frame, a first gripping assembly and a second gripping assembly. The x-ray tomography system has an x-ray source and an x-ray detector. The test specimen is attachable to the first gripping assembly and to the second gripping assembly and positionable between the x-ray source and the x-ray detector. The at least one tracking feature is attached to the test specimen wherein the at least one tracking feature is positionable between the x-ray source and the x-ray detector.

### CROSS-REFERENCE TO RELATED APPLICATION

The present application claims priority from U.S. Patent App. Ser. No. 63/713,011 filed Oct. 28, 2024, entitled “Tomography Error Correction System and Method”, the entire disclosure of which is hereby incorporated by reference in its entirety.

### BACKGROUND OF THE DISCLOSURE

### 1. Field of the Disclosure

The disclosure relates in general to tomography, and more particularly, to a tomography error correction system and method.

### 2. Background Art

Advanced X-ray tomography units have evolved to sub-micron spatial resolution. Beam line tomography, industrial CT scanners, microCT scanners and X-ray microscopes rotate a test specimen exposed to an X-ray beam or cone.

Typical commercially available thrust bearings have 2.5 micron runout. Runout is the discrepancy from a perfect circle, measured peak to peak. A 2.5 micron runout results in resolution that is no better than 1.25 microns. Bearings also exhibit other anomalies such as rotation axis tilt that will affect tomography applications at some level of spatial resolution.

Using a marker(s), such as a ball to calibrate runout is well known. Runout and/or other rotation axis anomalies are typically calibrated once. The marker(s) are then removed before the subsequent scan. Additionally, typically, only one bearing is calibrated in a CT scan. Researchers use existing features in scans to make some corrections. However, these existing features do not always exist and even when they do, they offer only modest correction. Moreover, using existing features requires image analysis expertise. In addition, using features of a Device Under Test (DUT) assumes there is no motion or deformation of the test object during the scanning process, and does not allow a distinction between rotation axis anomalies and such motions/deformations. This makes it difficult to properly diagnose scanning problems and make appropriate corrections.

Typical calibration relies on bearing runout for spatial resolution. For example, Nikon microCT scanners use Newport stages with 4 micron runout, so their best spatial resolution is 2 microns. Another typical example includes use of active bearings that enable high spatial resolution, but with substantial added complexity.

Some solutions have been proposed, including, but not limited to that which is disclosed in PCT Pat. App. Pub. No. WO 2022/266542. While such solutions have shown improvement, drawbacks nevertheless remain.

### SUMMARY OF THE DISCLOSURE

The disclosure is directed to a system comprising a load frame assembly, an x-ray tomography system; a test specimen and at least one tracking feature. The load frame assembly comprises a load frame, a first gripping assembly and a second gripping assembly. The x-ray tomography system comprises an x-ray source and an x-ray detector. The test specimen is attachable to the first gripping assembly and to the second gripping assembly and positionable between the x-ray source and the x-ray detector. The at least one tracking feature is attached to the test specimen wherein the at least one tracking feature is positionable between the x-ray source and the x-ray detector.

In some configurations, the test specimen includes a first end and a second end opposite the first end. The first end is attachable to the first gripping assembly and the second end attachable to the second gripping assembly.

In some configurations, the at least one tracking feature comprises a first tracking feature positioned proximate the first end of the test specimen and a second tracking feature positioned proximate the second end of the test specimen.

In some configurations, at least one of the first tracking feature and the second tracking feature comprises a spherical element.

In some configurations, the first tracking feature and the second tracking feature are positioned approximately 180° apart from each other.

In some configurations, the at least one tracking feature comprises a first tracking feature that comprises a spherical element.

In some configurations, the at least one tracking feature is adhered to the test specimen.

In another aspect of the disclosure, the disclosure is directed to a system comprising a load frame, an x-ray tomography system and at least one tracking features. The load frame assembly comprises a load frame, a first gripping assembly and a second gripping assembly. The x-ray tomography system comprising an x-ray source and an x-ray detector. The at least one tracking feature is attachable to a test specimen in a configuration wherein the at least one tracking feature is positionable between the x-ray source and the x-ray detector upon attachment to the test specimen and attachment thereof to the first gripping assembly and to the second gripping assembly.

In some configurations, the at least one tracking feature comprises at least two tracking features.

In some configurations, each of the at least two tracking features comprises a spherical element.

In yet another aspect of the disclosure, the disclosure is directed to a method of error correction in tomography, using the systems disclosed herein. The method comprises the steps of: providing a test specimen; attaching the at least one tracking feature to the test specimen; attaching the test specimen to the first gripping assembly and to the second gripping assembly; rotating the test specimen about an axis of rotation; capturing a plurality of images from the x-ray tomography system; creating a 3D representation of the test specimen from the plurality of images.

In some configurations, the method further comprises the step of detecting anomalies in the 3D representation.

In some configurations, the method further comprises the step of minimizing the anomalies.

### BRIEF DESCRIPTION OF THE DRAWINGS

The disclosure will now be described with reference to the drawings wherein:

FIG. 1 of the drawings is a comprises a schematic representation of the system of the present disclosure;

FIG. 2 of the drawings is a side elevational view of a load frame assembly of the present disclosure, showing, in particular, the test specimen and a pair of tracking features;

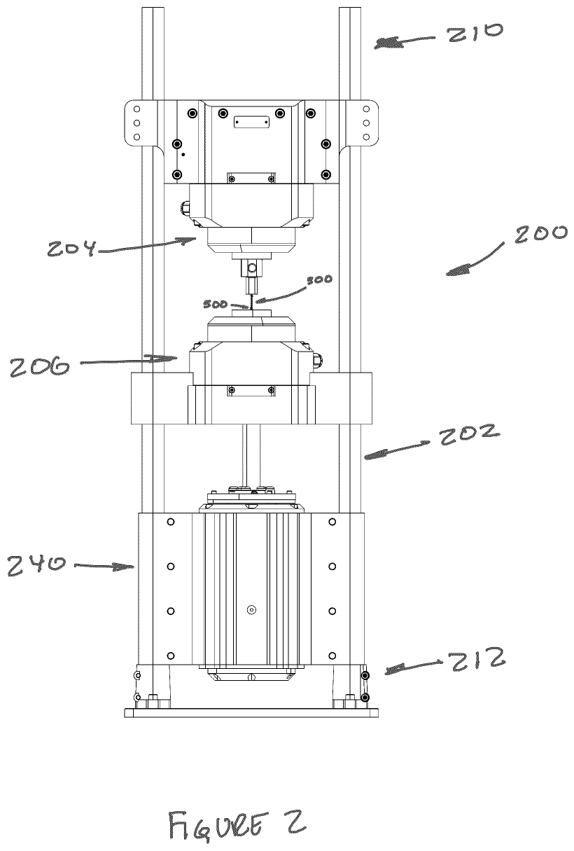

FIG. 2a of the drawings is a partial side elevational view of the load frame assembly of the present disclosure shown of FIG. 2, showing, in greater detail, the test specimen and the tracking features; and

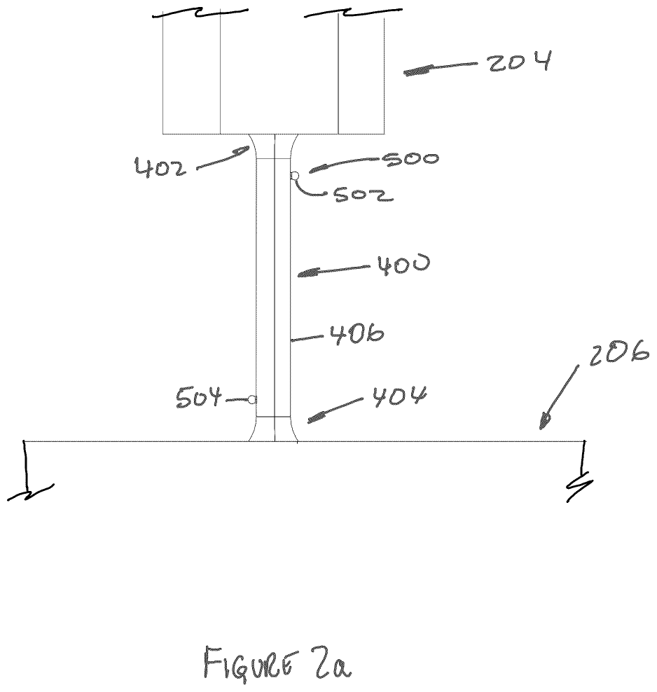

FIG. 3 of the drawings is an example schematic representation of a general-purpose computing device that can be used to execute tomography error correcting software, in accordance with at least one configuration disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

The configuration(s) disclosed herein includes a system for correcting for anomalies that may be introduced due to the different

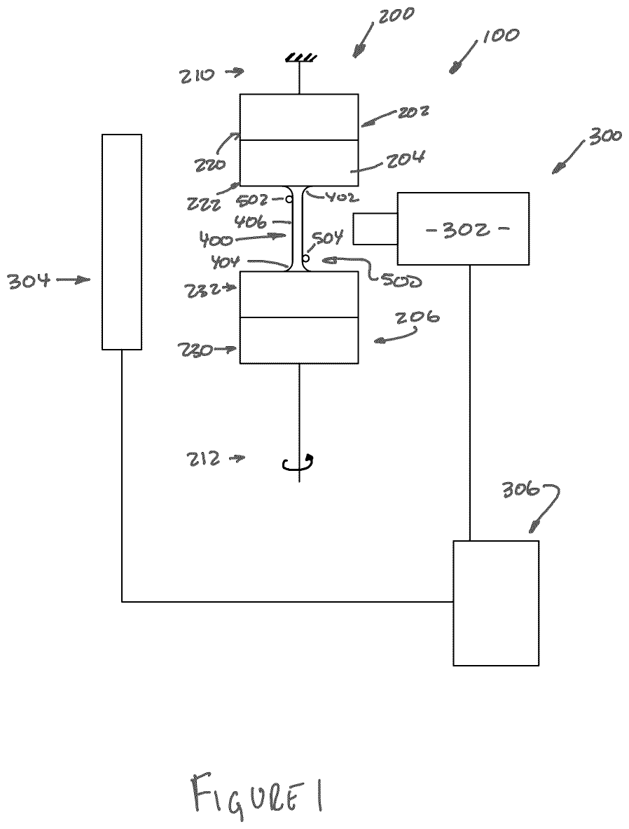

Referring now to the drawings and in particular to FIG. 1, a system 100 is disclosed that is a hardware component and tracking features as well as post processing software, such as tomography error correcting software that is on a general purpose computing device. In greater detail, system 100 includes load frame assembly 200, x-ray tomography system 300, test specimen 400 and tracking features 500.

The load frame assembly 200 comprises a load frame member 202, first gripping assembly 204 and second gripping assembly 206. The load frame member 202 comprises an elongated member having a first end 210 and a second end 212. Generally the load frame comprises a substantially rigid member, which may comprise two elongated spaced apart mounting rod members that extend from a base. Of course, a number of different configurations are contemplated, and, the load frame disclosed herein comprises solely an example of a load frame, and is not to be deemed limiting.

The first gripping assembly 204 includes first grip 222. The first grip may be attached to the load frame through a first bearing 220, which may comprise a thrust bearing. The first gripping assembly is positioned toward the first end 210 of the load frame 202. In the configuration shown, the first gripping assembly 204 is coupled to each of the rod members so as to be substantially fixed thereto.

The second gripping assembly 206 is shown as comprising a second grip 232, which may be attached to the load frame through a second bearing 230, which may comprise a thrust bearing. The second gripping assembly is spaced apart from the first gripping assembly so as to be positioned between the second end (in the configuration shown, the base) and the first gripping assembly 204. In the configuration shown, the second gripping assembly may be movable (through an actuation device 240) toward and away from the first gripping assembly 204, and may be rotatable relative to the first gripping assembly 204 and, the load frame 202. In the configuration shown, the second gripping assembly is slidably movable along the opposing rod members toward and away from the first gripping assembly.

The x-ray tomography system 300 is shown in FIG. 1, schematically, as x-ray source 302, x-ray detector 304 and general purpose computing device 306. The x-ray tomography system is positioned around the load frame assembly 200, in the configuration shown. It will be understood that the general purpose computing device 306 may be remotely positioned, for example. The x-ray source 302 is positioned proximate the test specimen 400 so as to impart x-rays onto the x-ray detector 304. In some configurations, they may be on opposing sides of each other.

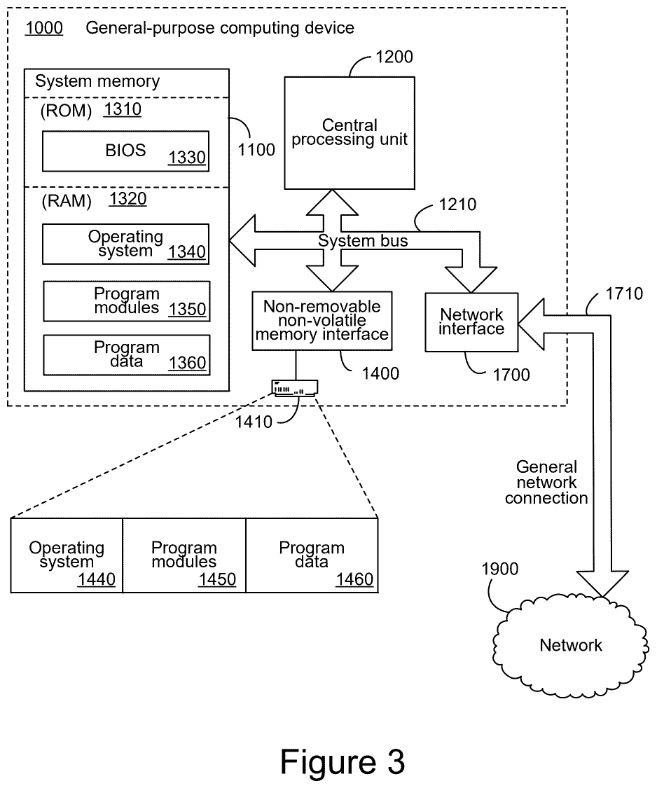

The general-purpose computing device 306, also, computing device 1000 may be of the type utilized for executing for executing tomography error correcting software (FIG. 1) as well as the X-ray tomography system 300 (FIG. 1). As such, it will be described with the understanding that variations can be made thereto. The exemplary general-purpose computing device 1000 can include, but is not limited to, one or more central processing units (CPUs) 1200, a system memory 1300, such as including a Read Only Memory (ROM) 1310 to store a Basic Input/Output System (BIOS) 1330 and a Random Access Memory (RAM) 1320, and a system bus 1210 that couples various system components including the system memory to the processing unit 1200. The system bus 1210 may be any of several types of bus structures including a memory bus or memory controller, a peripheral bus, and a local bus using any of a variety of bus architectures. Depending on the specific physical implementation, one or more of the CPUs 1200, the system memory 1300 and other components of the general-purpose computing device 1000 can be physically co-located, such as on a single chip. In such a case, some or all of the system bus 1210 can be nothing more than communicational pathways within a single chip structure and its illustration in FIG. 3 can be nothing more than notational convenience for the purpose of illustration.

The general-purpose computing device 1000 also typically includes computer readable media, which can include any available media that can be accessed by computing device 1000. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 1000. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 1000 may operate in a networked environment via logical connections to one or more remote computers. The logical connection depicted in FIG. 3 is a general network connection 1710 to the network 1900, which can be a local area network (LAN), a wide area network (WAN) such as the Internet, or other networks. The computing device 1000 is connected to the general network connection 1710 through a network interface or adapter 1700 that is, in turn, connected to the system bus 1210. In a networked environment, program modules depicted relative to the general-purpose computing device 1000, or portions or peripherals thereof, may be stored in the memory of one or more other computing devices that are communicatively coupled to the general-purpose computing device 1000 through the general network connection 1710. It will be appreciated that the network connections shown are exemplary and other means of establishing a communications link between computing devices may be used.

The general-purpose computing device 1000 may also include other removable/non-removable, volatile/nonvolatile computer storage media. By way of example only, FIG. 3 illustrates a hard disk drive 1410 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 1410 is typically connected to the system bus 1210 through a non-removable memory interface such as interface 1400.

The drives and their associated computer storage media discussed above and illustrated in FIG. 3, provide storage of computer readable instructions, data structures, program modules and other data for the general-purpose computing device 1000. In FIG. 3, for example, hard disk drive 1410 is illustrated as storing operating system 1440, other program modules 1450, and program data 1460. Note that these components can either be the same as or different from operating system 1340, other program modules 1350 and program data 1360, stored in RAM 1320. Operating system 1440, other program modules 1450 and program data 1460 are given different numbers here to illustrate that, at a minimum, they are different copies.

The test specimen 400 comprises an elongated member that is defined by first end 402 and second 404, and further defining outer surface 406. Such a specimen may comprise metal or metal alloy, a composite material, a polymer, among others. There is no particular limitation to the specific material that is being tested in the system.

The tracking features 500 comprise a plurality of tracking elements that are attached (i.e., adhered, or otherwise connected to) the test specimen 400. In the configuration shown, two tracking elements are disclosed, a first and second tracking element 502, 504. The first tracking element 502 comprises a spherical element that is adhered to the test specimen. The second tracking element 504 comprises a spherical element that is adhered to the test specimen. In the configuration shown, the first tracking element is positioned proximate the first gripping assembly 204 and on a side proximate a first rod member of the load frame. The second tracking element is positioned proximate the second gripping assembly and on a side proximate a second rod member of the load frame. Thus, the two elements may be positioned approximately 180° apart from each other.

In other configurations, it is contemplated that a single tracking feature may be utilized, whereas in other configuration, more than two tracking elements are contemplated for use. They may be attached to different regions of the specimen.

In operation, it will be understood that by positioning the tracking features directly on the sample, through bonding, adhering or the like, the specimen itself is being monitored instead of structures that are separate from the specimen. As will be understood that tomographic reconstruction generally presumes a perfect sample rotation about a single axis of motion. However, it will be understood that the rotation of the sample, or other movement is generally imperfect. As such, the operation leads to blurred and distorted volumetric reconstruction.

The process of operation is such that tracking features are attached to the sample. While tracking features are positioned on opposing sides and ends of the sample, tracking features may be near the bottom, the top, multiple tracking features may be positioned on multiple different positions on the specimen.

The tracking features are located in a 2D detector plane by analyzing the projection of the image data, through the collection of a number of images by the detector as the specimen is rotated. A 3D representation of the scanner geometry can be created from standard measurements. For example, the scanner-to-sample distance, scanner-to-detector distance, detector size and pixel configuration my be utilized, among others.

The 2D tracking feature position data and the 3D scanner geometric representation are linked by establishing, through an optimization process, the substantially optimal circular path of the tracking feature within the 3D scanner geometric representation that recreates the path of the tracking feature in the 2d projection space.

Once determined, discrepancies between the projection of the tracking feature path onto the detector plane when compared to the actual tracking feature measured in the detector path is defined as an anomaly. As will be appreciated, with the use of multiple tracking features, misalignment between the central axes of the tracking feature bead paths can be defined as an anomaly.

Once these discrepancies can be identified, the discrepancies and anomalies in the reconstruction process can be minimized (and preferably eliminated) through a number of different techniques. For example, hardware adjustments and modifications can be made to the system to improve the match between the measured and projected tracking feature paths. In other configurations, translation/rotation/warping of the projection images may be employed to improve the match between the measured and projected tracking feature paths. This may involve a single process applied to each one of the projections in a projection sequence. In other configurations, this may comprise a process applied to each individual projection. Further still, translation/rotation/warping of the reconstruction voxel space can be employed to improve the match between measured and projected tracking feature paths. It is contemplated that this may occur a single process applied to the entire voxel space, or to processes applied at different orientations of the voxel space. It will further be understood that the foregoing (among other) processes for minimizing discrepancies and anomalies in the reconstruction process may be independent of or work in conjunction with the reconstruction software, such as standard rotation axis and orientation adjustments of the specimen within the load frame assembly.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A system comprising:
a load frame assembly comprising a load frame, a first gripping assembly and a second gripping assembly;
an x-ray tomography system comprising an x-ray source and an x-ray detector;
a test specimen attachable to the first gripping assembly and to the second gripping assembly and positionable between the x-ray source and the x-ray detector; and
at least one tracking feature being attached to the test specimen wherein the at least one tracking feature is positionable between the x-ray source and the x-ray detector.

2. The system of claim 1 wherein the test specimen includes a first end and a second end opposite the first end, the first end attachable to the first gripping assembly and the second end attachable to the second gripping assembly.

3. The system of claim 2 wherein the at least one tracking feature comprises a first tracking feature positioned proximate the first end of the test specimen and a second tracking feature positioned proximate the second end of the test specimen.

4. The system of claim 3 wherein at least one of the first tracking feature and the second tracking feature comprises a spherical element.

5. The system of claim 2 wherein the first tracking feature and the second tracking feature are positioned approximately 180° apart from each other.

6. The system of claim 2 wherein the at least one tracking feature comprises a first tracking feature that comprises a spherical element.

7. The system of claim 1 wherein the at least one tracking feature is adhered to the test specimen.

8. A system comprising:
a load frame assembly comprising a load frame, a first gripping assembly and a second gripping assembly;
an x-ray tomography system comprising an x-ray source and an x-ray detector; and
at least one tracking feature attachable to a test specimen in a configuration wherein the at least one tracking feature is positionable between the x-ray source and the x-ray detector upon attachment to the test specimen and attachment thereof to the first gripping assembly and to the second gripping assembly.

9. The system of claim 8 wherein the at least one tracking feature comprises at least two tracking features.

10. The system of claim 9 wherein each of the at least two tracking features comprises a spherical element.

11. A method of error correction in tomography, using the system of claim 8, comprising the steps of:
providing a test specimen;
attaching the at least one tracking feature to the test specimen;
attaching the test specimen to the first gripping assembly and to the second gripping assembly;
rotating the test specimen about an axis of rotation;
capturing a plurality of images from the x-ray tomography system;
creating a 3D representation of the test specimen from the plurality of images.

12. The method of claim 11 further comprising the step of:
detecting anomalies in the 3D representation.

13. The method of claim 12 further comprising the step of: minimzing the anomalies.
